(19) United States
(12) Patent Application Publication
(10) Pub. No.: US 2025/0070900 A1
(43) Pub. Date: Feb. 27, 2025

(54) INTERFERENCE INFORMATION OUTPUT DEVICE, INTERFERENCE INFORMATION OUTPUT METHOD, AND RECORDING MEDIUM

(71) Applicant: NEC Corporation, Minato-ku, Tokyo (JP)

(72) Inventors: Masato KITA, Tokyo (JP); Takashi Kuribara, Tokyo (JP); Kohei Sugai, Tokyo (JP); Ryosuke Kumagai, Tokyo (JP)

(73) Assignee: NEC Corporation, Minato-ku, Tokyo (JP)

(21) Appl. No.: 18/729,266

(22) PCT Filed: Feb. 18, 2022
(86) PCT No.: PCT/JP2022/006692

§ 371 Date: Jul. 16, 2024

(51) Int. Cl. H04B 17/345; H04W 64/00

(52) U.S. Cl. CPC H04B 17/345; H04W 64/00

(57) ABSTRACT

In order to enable to output information for enabling recognizing likelihood of occurrence of radio wave interference more easily, this interference information output device comprises: reception means for receiving, with respect to a plurality of wireless communication terminals, location information being information relating to presence locations of the wireless communication terminals; calculation means for calculating, based on the location information, a degree of congestion of the wireless communication terminals; estimation means for estimating, based on an estimation condition, occurrence of radio wave interference; and output means for outputting interference information being information relating to a result of the estimation. The estimation condition includes a condition relating to the degree of congestion.

### TECHNICAL FIELD

The present invention relates to an interference information output device and the like.

### BACKGROUND ART

In wireless communication, as a factor of decreasing a throughput, radio wave interference is present. When radio wave interference occurs and a throughput is decreased, quality of a service provided based on wireless communication may be decreased. The decrease in service quality includes, for example, turbulence of a reproduced video or voice, degradation of control accuracy in remote control, and the like.

Some automatic operation devices moving automatically such as a self-driving car and a drone use wireless communication. The wireless communication is used for transmission of information acquired, for example, by operation control of an automatic operation device or an automatic operation device, and the like. Information to be transmitted by the automatic operation device includes, for example, information acquired by a camera, a sensor, or the like mounted on the automatic operation device.

In such wireless communication, radio wave interference may occur and affect operation control and transmission of information. For example, a failure of the operation control and missing of information transmitted from the automatic operation device may occur. Therefore, the automatic operation device desirably moves by avoiding radio wave interference.

An investigation of whether radio wave interference is occurring is generally conducted by an investigator visiting a site where a decrease in service quality is occurring and then the investigator investigating a peripheral radio wave situation and the like.

As a related art, there is a technique described in PTL 1.

### CITATION LIST

### Patent Literature

PTL 1: Japanese Unexamined Patent Application Publication No. 2008-026095

### SUMMARY OF INVENTION

### Technical Problem

However, in a general method, as described above, for investigating radio wave interference, it is difficult for an automatic operation device, an administrator of an automatic operation device, or the like to easily recognize likelihood of occurrence of radio wave interference. Therefore, it is difficult to move the automatic operation device by avoiding radio wave interference. Therefore, it is desirable that an automatic operation device, an administrator of an automatic operation device, or the like can easily recognize likelihood of occurrence of radio wave interference.

In view of the above-described problem, an object of the present invention is to provide an interference information output device and the like capable of outputting information for enabling recognizing likelihood of occurrence of radio wave interference more easily.

### Solution to Problem

According to one aspect of the present invention, an interference information output device includes: a reception means for receiving, with respect to a plurality of wireless communication terminals, location information being information relating to presence locations of the wireless communication terminals: a calculation means for calculating, based on the location information, a degree of congestion of the wireless communication terminals: an estimation means for estimating, based on an estimation condition, occurrence of radio wave interference; and an output means for outputting interference information being information relating to a result of the estimation, wherein the estimation condition includes a condition relating to the degree of congestion.

According to another aspect of the present invention, an interference information output method includes receiving, with respect to a plurality of wireless communication terminals, location information being information relating to presence locations of the wireless communication terminals, calculating, based on the location information, a degree of congestion of the wireless communication terminals, estimating, based on an estimation condition, occurrence of radio wave interference, and outputting interference information being information relating to a result of the estimation, wherein the estimation condition includes a condition relating to the degree of congestion.

According to still another aspect of the present invention, an interference information output program recorded in a computer-readable recording medium causes a computer to achieve: a reception function of receiving, with respect to a plurality of wireless communication terminals, location information being information relating to presence locations of the wireless communication terminals: a calculation function of calculating, based on the location information, a degree of congestion of the wireless communication terminals: an estimation function of estimating, based on an estimation condition being a condition, occurrence of radio wave interference; and an output function of outputting interference information being information relating to a result of the estimation, wherein the estimation condition includes a condition relating to the degree of congestion.

According to still another aspect of the present invention, an interference information output system includes: a reception means for receiving, with respect to a plurality of wireless communication terminals, location information being information relating to presence locations of the wireless communication terminals; a calculation means for calculating, based on the location information, a degree of congestion of the wireless communication terminals: an estimation means for estimating, based on an estimation condition, occurrence of radio wave interference; and an output means for outputting interference information being information relating to a result of the estimation, wherein the estimation condition includes a condition relating to the degree of congestion.

### Advantageous Effects of Invention

According to the present invention, information for enabling recognizing likelihood of occurrence of radio wave interference more easily can be output.

### BRIEF DESCRIPTION OF DRAWINGS

FIG. 1 is a diagram illustrating a configuration example of an interference information output device according to a first example embodiment of the present invention.

FIG. 2 is a diagram illustrating an example of an operation flow of the interference information output device according to the first example embodiment of the present invention.

FIG. 3 is a diagram illustrating a configuration example of a system including an interference information output device according to a second example embodiment of the present invention.

FIG. 4 is a diagram illustrating a configuration example of the interference information output device according to the second example embodiment of the present invention.

FIG. 5 is a diagram illustrating another configuration example of the interference information output device according to the second example embodiment of the present invention.

FIG. 6 is a diagram of an image displayed, in a display means, by the interference information output device according to the second example embodiment of the present invention.

FIG. 7 is a diagram illustrating an example of an operation flow of the interference information output device according to the second example embodiment of the present invention.

FIG. 8 is a diagram illustrating a hardware configuration example according to each example embodiment of the present invention.

### EXAMPLE EMBODIMENT

### First Example Embodiment

A first example embodiment of the present invention is described.

Note that a specific example of an interference information output device 10 according to the first example embodiment is an interference information output device 20 according to a second example embodiment to be described later.

First, a configuration example of the interference information output device 10 according to the present example embodiment is described.

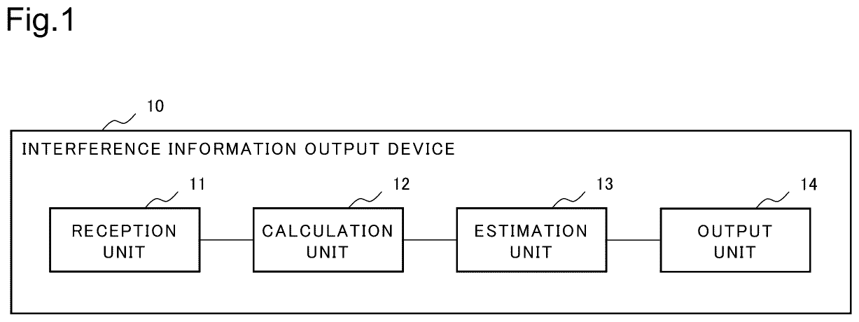

FIG. 1 illustrates a configuration example of the interference information output device 10 according to the present example embodiment. The interference information output device 10 includes a reception unit 11, a calculation unit 12, an estimation unit 13, and an output unit 14.

The reception unit 11 receives, with respect to a plurality of wireless communication terminals, location information. The location information is information relating to a presence location of a wireless communication terminal. The calculation unit 12 calculates, based on the location information, a degree of congestion of the wireless communication terminals. The estimation unit 13 estimates, based on an estimation condition, occurrence of radio wave interference. The estimation condition includes a condition relating to the degree of congestion. The output unit 14 outputs interference information. The interference information is information relating to a result of the estimation.

Next, an example of an operation flow of the interference information output device 10 according to the present example embodiment is described.

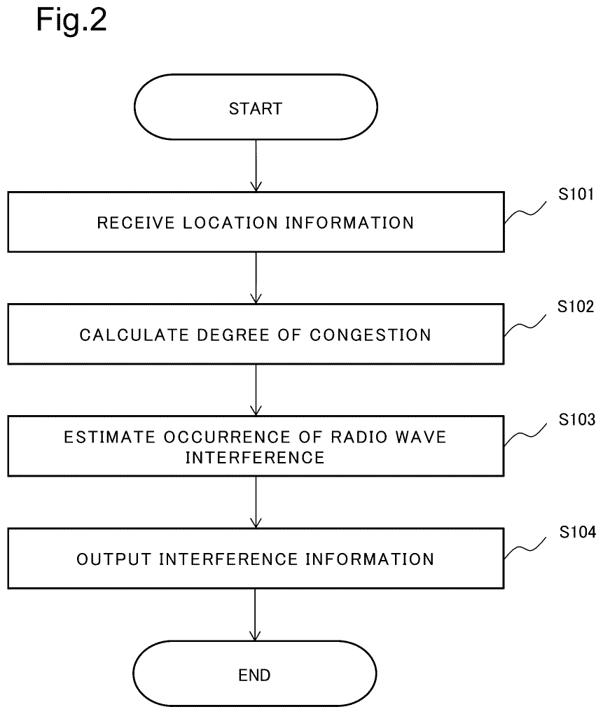

FIG. 2 illustrates an example of an operation flow of the interference information output device 10 according to the present example embodiment.

The reception unit 11 receives, with respect to a plurality of wireless communication terminals, location information (step S101). The calculation unit 12 calculates, based on the location information, a degree of congestion of the wireless communication terminals (step S102). The estimation unit 13 estimates, based on an estimation condition, occurrence of radio wave interference (step S103). A specific method for the estimation is described according to the second example embodiment. The output unit 14 outputs interference information (step S104).

As described above, according to the first example embodiment of the present invention, the interference information output device 10 includes the reception unit 11, the calculation unit 12, the estimation unit 13, and the output unit 14. The reception unit 11 receives, with respect to a plurality of wireless communication terminals, location information. The location information is information relating to a presence location of a wireless communication terminal. The calculation unit 12 calculates, based on the location information, a degree of congestion of the wireless communication terminals. The estimation unit 13 estimates, based on an estimation condition, occurrence of radio wave interference. The estimation condition includes a condition relating to the degree of congestion. The output unit 14 outputs interference information. The interference information is information relating to a result of the estimation.

In this manner, the interference information output device 10 conducts an estimation, based on a degree of congestion of wireless communication terminals. The interference information output device 10 outputs interference information relating to a result of the estimation. Thereby, a device which receives the interference information and a user who refers to the interference information can recognize a likelihood of occurrence of radio wave interference more easily. Therefore, information for enabling to recognize a likelihood of occurrence of radio wave interference can be output more easily.

### Second Example Embodiment

Next, an interference information output device 20 according to the second example embodiment of the present invention is described. A specific example of the interference information output device 10 according to the first example embodiment is the interference information output device 20 according to the second example embodiment.

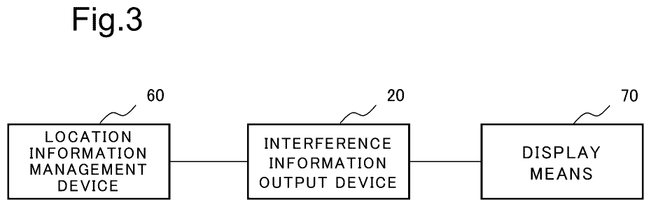

First, FIG. 3 illustrates a configuration example of a system including the interference information output device 20 according to the present example embodiment. The interference information output device 20 is connected to a location information management device 60 each other. The interference information output device 20 is connected to a display means 70 each other.

The location information management device 60 manages location information with respect to a plurality of wireless communication terminals. The location information is information relating to a presence location of a wireless communication terminal. According to the present example embodiment, the location information includes operation information. The operation information is information relating to an operation of a wireless communication terminal.

The operation information may include, for example, information of an association relation between a date and time and a presence location of a wireless communication terminal. In this case, the date and time may include a date and time in any one of a present, a past, and a future. The operation information may include, for example, information indicating when and where a wireless communication terminal is scheduled to pass.

The operation information may include, for example, information of a current location of a wireless communication terminal and information of a movement velocity (a speed and a direction). The operation information may include, for a wireless communication terminal, for example, at least any one of pieces of information such as a start location, a start time, an arrival location, an arrival time, a path, and an auxiliary path for a case such as weather badness and congestion occurrence.

Operation information is previously registered in the location information management device 60. The operation information is registered, for example, by an operator of a wireless communication terminal, in the location information management device 60. The operation information may be updated, according to an operation state of the wireless communication terminal. When, for example, with movement of a wireless communication terminal, operation information of the wireless communication terminal is updated, the location information management device 60 may receive operation information from a terminal management device (not illustrated) managing the wireless communication terminal or the wireless communication terminal.

The location information may include information indicating a presence information of a wireless communication terminal at a current time. The location information may further include at least either of discrimination information of the wireless communication terminal and frequency information of the wireless communication terminal. The location information may not include operation information.

A wireless communication terminal (not illustrated) performs wireless communication. The wireless communication terminal according to the present example embodiment is a wireless communication terminal in which the location information management device 60 can recognize location information. The wireless communication terminal is, for example, a drone, a self-driving car, or the like.

The interference information output device 20 receives, with respect to a plurality of wireless communication terminals, location information. The interference information output device 20 outputs interference information. The interference information output device 20 is described later. The location information is information relating to a presence location of a wireless communication terminal. The interference information is information relating to a result of an estimation of occurrence of radio wave interference.

According to the present example embodiment, the interference information output device 20 receives location information from the location information management device 60. The interference information output device 20 may receive location information from each of wireless communication terminals. The location information management device 60 may receive location information, for example, from each of wireless communication terminals and transmit the received location information to the interference information output device 20.

The display means 70 is a man-machine interface such as a display as an output device. The display means 70 displays an image. According to the present example embodiment, it is assumed that the interference information output device 20 outputs interference information to the display means 70. However, an output destination of interference information is optional. The interference information output device 20 may output interference information to an output destination other than the display means 70.

The display means 70 may be a display or the like disposed in a monitoring center or the like monitoring radio wave interference. The display means 70 may be mounted on a wireless communication terminal.

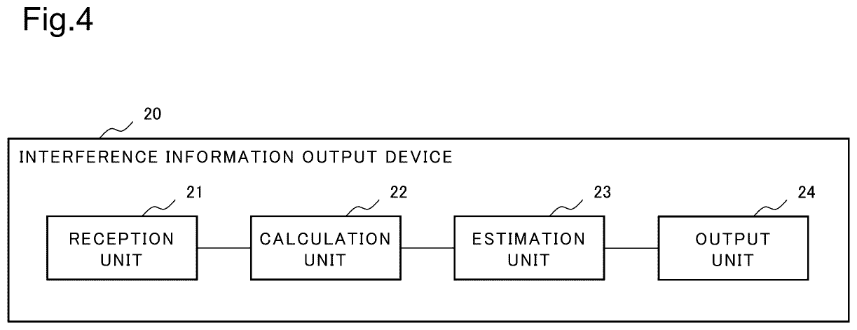

Next, FIG. 4 illustrates a configuration example of the interference information output device 20 according to the present example embodiment. The interference information output device 20 according to the present example embodiment includes a reception unit 21, a calculation unit 22, an estimation unit 23, and an output unit 24.

The reception unit 21 receives location information with respect to a plurality of wireless communication terminals from the location information management device 60. The reception unit 21 may receive location information at every predetermined time. According to the present example embodiment, the location information includes operation information. The operation information is information relating to an operation of a wireless communication terminal.

The calculation unit 22 calculates, based on the location information, a degree of congestion of wireless communication terminals. The degree of congestion is, for example, a number of units of wireless communication terminals per unit volume or per unit area. In other words, the degree of congestion is a density of wireless communication terminals. When frequency information of wireless communication terminals is included in the location information, the calculation unit 22 may calculate a degree of congestion with respect to wireless communication terminals using a specific frequency or frequency band. When frequency information of wireless communication terminals is included in the location information, the calculation unit 22 may calculate a degree of congestion with respect to each frequency or each frequency band. The calculation unit 22 may calculate a degree of congestion with respect to each of a plurality, one or two or more, of areas (spaces or planes). The area in this case may be defined in accordance with a predetermined rule. The area may have, for example, a lattice-like shape, a circular shape, a spherical shape, or another shape.

The estimation unit 23 estimates, based on an estimation condition, occurrence of radio wave interference. The estimation condition is a condition satisfied when it is estimated that radio wave interference is occurring. The estimation condition includes a condition relating to a degree of congestion. A specific example of the estimation condition is described later.

The estimation unit 23 estimates, when an estimation condition is satisfied in a specific date and time and a specific location, that radio wave interference occurs in the date and time and the location. When the location information is information indicating a presence location at a current time of a wireless communication terminal, the estimation unit 23 estimates, for a specific area, whether radio wave interference is occurring at the current time. The estimation unit 23 may estimate an area in which radio wave interference is occurring at a current time. The estimation unit 23, for example the calculation unit 22, may estimate, for each of a plurality, one or two or more, of areas (spaces or planes), occurrence presence/absence of radio wave interference. The area in this case may be defined in accordance with a predetermined rule.

When the location information includes future operation information, the estimation unit 23 can estimate occurrence presence/absence or an occurrence area of radio wave interference in a future date and time. When the location information includes past operation information, the estimation unit 23 can estimate occurrence presence/absence or an occurrence area of radio wave interference in a past date and time. The estimation unit 23 estimates, based on operation information and an estimation condition, occurrence of radio wave interference with respect to a date and time in any one of a present, a future, and a past.

The output unit 24 outputs interference information. The interference information is information relating to a result of an estimation. According to the present example embodiment, the output unit 24 outputs interference information to the display means 70. According to the present example embodiment, the interference information is image information for displaying, in the display means 70, an image indicating information relating to a result of an estimation. In other words, the output unit 24 outputs interference information to the display means 70 and thereby, causes the display means 70 to display an image indicating information relating to a result of an estimation.

Next, an example of an estimation condition is described.

The estimation condition is that, for example, a degree of congestion of wireless communication terminals is equal to or more than a threshold. When a degree of congestion of wireless communication terminals is equal to or more than the threshold, wireless communication is congested and due to this, a likelihood of occurrence of radio wave interference is high. Therefore, the estimation unit 23 estimates, as a location where a likelihood of occurrence of radio wave interference is high, a location where a degree of congestion of wireless communication terminals is high.

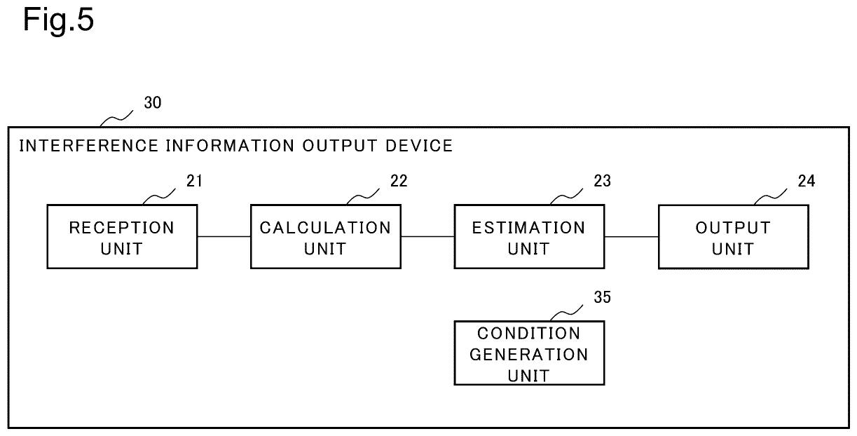

An estimation condition may be generated based on a past history. The history is, for example, a history of a degree of congestion of wireless communication terminals. The estimation unit 23 causes, for example, a storage unit (not illustrated) to store the history of a degree of congestion. The condition generation unit 35 generates, based on the history of a degree of congestion, a condition for a date and time and a location in which a degree of congestion is estimated to be equal to or more than a threshold. The condition generation unit 35 may be included inside the interference information output device or may be disposed outside the interference information output device 20. The condition generation unit 35 may generate, for example, based on machine learning, an estimation condition. Note that FIG. 5 illustrates a configuration example of an interference information output device 30 including a condition generation unit 35.

The history may be information of a degree of congestion in which radio wave interference actually occurred in a past. In this case, the condition generation unit 35 receives information of a date and time and a location in which radio wave interference actually occurred in a past. Then, the condition generation unit 35 may generate a condition for a degree of congestion in which it is estimated that radio wave interference is occurring. In this case, the condition generation unit 35 can generate an estimation condition, based on a history of a degree of congestion in a date and time and a location in which radio wave interference actually occurred in a past.

The estimation condition may be a condition in which a plurality, two or more, of the above-described individual estimation conditions are combined. The individual estimation condition is thereafter referred to as an individual condition. For example, the estimation condition may be that any one or more individual conditions are satisfied or may be that a predetermined number or more of individual conditions are satisfied.

Next, a specific example of an image displayed, in the display means 70, by the output unit 24 is described.

The image may be, for example, an image in which an area in which a degree of congestion in a specific date and time is equal to or more than a threshold is displayed on a map. The specific date and time may be a current time or may be a time in a past or a future. The specific date and time may be modified according to setting input or the like from a user. The image may include estimation results in a plurality of dates and times. The image may be, for example, an image in which estimation results in a plurality of dates and times are displayed on a map in a superimposed manner. The image may be an image in which a map where an estimation result in one date and time is displayed is displayed, for a plurality of dates and times, in such a way that a plurality of maps are arranged.

The image may be an image in which an area where, in a specific frequency or frequency band, a degree of congestion is equal to or more than a threshold is displayed on a map. The specific frequency or frequency band may be modified according to setting input or the like from a user. The specific frequency or frequency band may include a frequency being used by a specific wireless communication terminal. The image may include estimation results in a plurality of frequencies or frequency bands. The image may be, for example, an image in which estimation results in a plurality of frequencies or frequency bands are displayed on one map in a superimposed manner. The image may be, an image in which estimation results in a plurality of frequencies or frequency bands are displayed in an arranged manner.

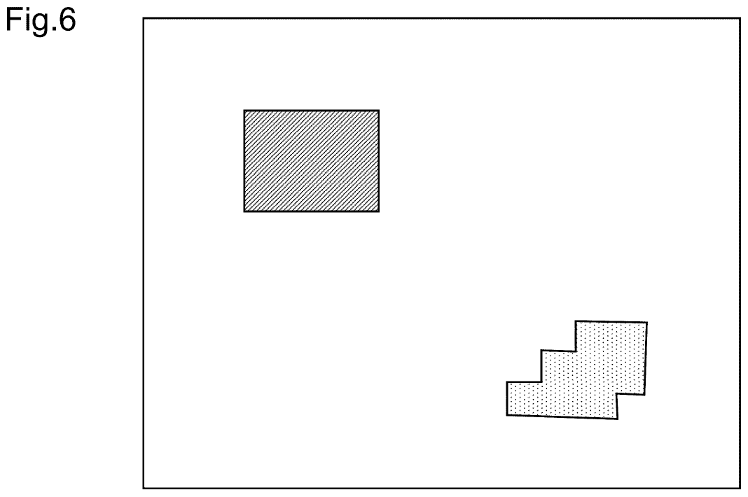

FIG. 6 is a diagram illustrating an example of an image displayed by a display means. An area in which a degree of congestion is equal to or more than a threshold may be displayed, according to a degree of congestion, by being discriminated based on a display format. The display format is, for example, a color, a contrasting density, or the like. The area in which a degree of congestion is equal to or more than a threshold may be displayed, according to a frequency or a frequency band, by being discriminated based on a display format or an image to be displayed. The area in which a degree of congestion is equal to or more than a threshold may be displayed, according to a date and time, by being discriminated based on a display format or an image to be displayed.

Interference information may include information relating to a movement direction of a specific wireless communication terminal. The movement direction is a direction of avoiding an area in which occurrence of radio wave interference is estimated. In this case, the estimation unit 23 determines, based on location information, whether a specific wireless communication terminal passes through an area in which occurrence of radio wave interference is estimated. The estimation unit 23 calculates, with respect to the wireless communication terminal, a movement direction of avoiding the area in which occurrence of radio wave interference is estimated.

Information relating to a movement direction may include information indicating a movement path. In this case, the estimation unit 23 calculates, with respect to a specific wireless communication terminal, a movement path of avoiding an area in which occurrence of radio wave interference is estimated. The estimation unit 23 can calculate a movement path, according to input indicating information of a start location and an arrival location or location information including information of a start location and an arrival location. A plurality of movement directions and a plurality of movement paths may be calculated. In this case, interference information may include information of a plurality of calculated movement directions. The interference information may include information of a plurality of calculated movement paths.

The output unit 24 may output interference information to an output destination being not the display means 70. In this case, the interference information may be data indicating information relating to a result of an estimation. The interference information may include, for example, any one or more of information indicating an area in which occurrence of radio wave interference is estimated, information of a frequency or a frequency band in which occurrence of radio wave interference is estimated, and information of a date and time in which occurrence of radio wave interference is estimated.

The output unit 24 may output, for example, to a specific wireless communication terminal, interference information. The specific wireless communication terminal is, for example, a wireless communication terminal previously set as an output destination of interference information and the like. In this case, the interference information may be, for example, information indicating that a specific wireless communication terminal is present in an area in which occurrence of radio wave interference is estimated. The interference information may be, for example, information indicating a date and time in which a specific wireless communication terminal arrives at an area in which occurrence of radio wave interference is estimated. In this case, the interference information may be image information for displaying an image in the display means 70. The image in this case includes information indicating a date and time in which a specific wireless communication terminal arrives at an area in which occurrence of radio wave interference is estimated.

In this case, the estimation unit 23 may estimate, with respect to a presence location of a specific wireless communication terminal, occurrence presence/absence of radio wave interference. The output unit 24 may output interference information to the wireless communication terminal and a monitoring device (not illustrated) installed in a monitoring center. In this case, the interference information may be information indicating that in the presence location of the wireless communication terminal, occurrence of radio wave interference is estimated. The wireless communication terminal may notify, based on an image or a voice, a user that occurrence of radio wave interference is being estimated.

The estimation unit 23 may estimate, based on an estimation condition and operation information of a specific wireless communication terminal, whether radio wave interference is occurring in a location where the wireless communication terminal passes and a date and time in which the wireless communication terminal is scheduled to pass. The output unit 24 may output interference information to the wireless communication terminal and a monitoring device. In this case, the interference information may be information of a date and time in which occurrence of radio wave interference is estimated. The interference information may be image information for displaying an image in the display means 70. In this case, the display means 70 may be mounted on a wireless communication terminal. The display means 70 may be disposed in a monitoring center.

The interference information may be control information for controlling a wireless communication terminal. The interference information may be, for example, control information for moving a wireless communication terminal in a movement direction of avoiding an area in which occurrence of radio wave interference is estimated.

When location information includes information of a location of a wireless communication terminal in a future date and time, the estimation unit 23 can estimate, based on a degree of congestion in the future date and time, an area in which radio wave interference is likely to occur. Therefore, the output unit 24 outputs interference information and thereby, can notify a wireless communication terminal passing through the area and a monitoring device that radio wave interference is likely to occur in the future date and time. Then, an operator of the wireless communication terminal or the like can take a countermeasure for modification or the like of a movement direction and a movement path of the wireless communication terminal in such a way as to avoid radio wave interference.

When the location information includes information of a location of a wireless communication terminal in a past date and time, the estimation unit 23 can estimate, based on a degree of congestion in the past date and time, an area in which radio wave interference may have occurred. Therefore, the output unit 24 outputs interference information and thereby, can issue a notification for information of an area in which radio wave interference may have occurred in a past.

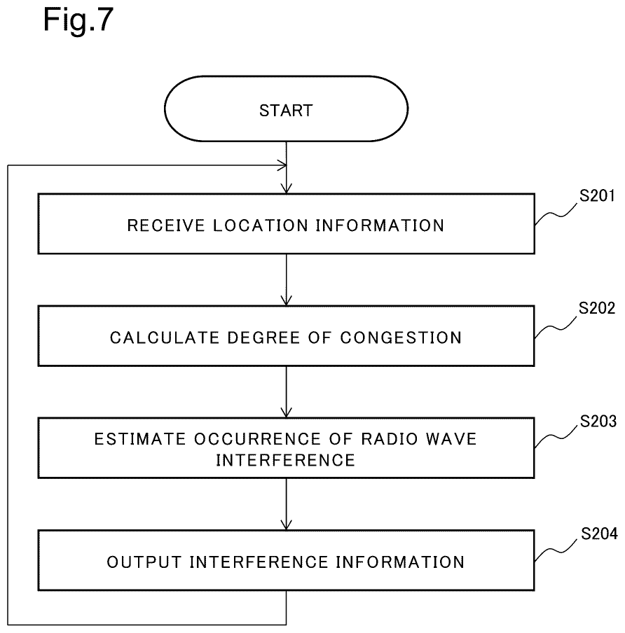

Next, FIG. 7 illustrates an example of an operation flow of the interference information output device 20 according to the present example embodiment.

The reception unit 21 receives, with respect to a plurality of wireless communication terminals, location information (step S201). According to the present example embodiment, the reception unit 11 receives, at a predetermined timing, location information from the location information management device 60. The predetermined timing is, for example, every predetermined time, a case where location information is modified, or the like.

The calculation unit 22 calculates, based on the location information, a degree of congestion of the wireless communication terminals (step S202). The estimation unit 23 estimates, based on an estimation condition, occurrence of radio wave interference (step S203).

The output unit 24 outputs interference information (step S204). According to the present example embodiment, the output unit 24 outputs interference information at every predetermined time. The output unit 24 may output interference information at any timing instead of every predetermined time. The output unit 24 may output interference information, for example, when a request is issued from a device of an output destination of interference information and when it is estimated that radio wave interference is occurring.

As described above, according to the second example embodiment of the present invention, the interference information output device 20 incudes the reception unit 21, the calculation unit 22, the estimation unit 23, and the output unit 24. The reception unit 21 receives, with respect to a plurality of wireless communication terminals, location information. The location information is information relating to a presence location of a wireless communication terminal. The calculation unit 22 calculates, based on the location information, a degree of congestion of the wireless communication terminals. The estimation unit 23 estimates, based on an estimation condition, occurrence of radio wave interference. The estimation condition includes a condition relating to the degree of congestion. The output unit 24 outputs interference information. The interference information is information relating to a result of the estimation.

In this manner, the interference information output device 20 conducts an estimation, based on a degree of congestion of wireless communication terminals. The interference information output device 20 outputs interference information relating to a result of the estimation. Thereby, a device which receives the interference information and a user who refers to the interference information can recognize a likelihood of occurrence of radio wave interference more easily. Therefore, information for enabling to recognize a likelihood of occurrence of radio wave interference more easily can be output.

The degree of congestion is a number of units of wireless communication terminals per unit volume or per unit area. Therefore, a location where a likelihood of occurrence of radio wave interference is high can be easily estimated.

The location information may include operation information of a wireless communication terminal. The operation information is information relating to an operation of the wireless communication terminal. The estimation unit 23 conducts, based on operation information and an estimation condition, an estimation with respect to a date and time in at least any one of a present, a future, or a past. Thereby, also for a future and a past, a likelihood of occurrence of radio wave interference is estimated and thereby, attention and the like can be made to a user.

The estimation unit 23 may estimate, based on an estimation condition and an operation information of a specific wireless communication terminal, whether, in a location where the wireless communication terminal passes, radio wave interference is occurring in a date and time in which the wireless communication terminal is scheduled to pass. The interference information may include, for the wireless communication terminal, information of a date and time in which occurrence of radio wave interference is estimated. This causes a user to recognize a date and time more easily in which occurrence of radio wave interference is estimated.

The output unit 24 may output interference information to the display means 70 that displays an image. The interference information may be image information for displaying an image in the display means 70. The image is an image in which a result of an estimation is displayed on a map. This causes a user to easily recognize a location where occurrence of radio wave interference is estimated.

The estimation unit 23 may calculate, based on location information, a movement direction of avoiding an area in which occurrence of radio wave interference is estimated, with respect to a specific wireless communication terminal. In this case, interference information may include, with respect to the wireless communication terminal, information relating to the movement direction. The interference information may include control information for moving the wireless communication terminal in the movement direction. Thereby, an influence of radio wave interference on the wireless communication terminal can be reduced.

### Hardware Configuration Example

A configuration example of hardware resources for achieving, by using one information processing device (computer), the interference information output devices (10, 20, and 30) according to the above-described example embodiments of the present invention is described. The interference information output device may be achieved by physically or functionally using at least two information processing devices. The interference information output device may be achieved as a dedicated device. Only a function of a part of the interference information output device may be achieved by using an information processing device.

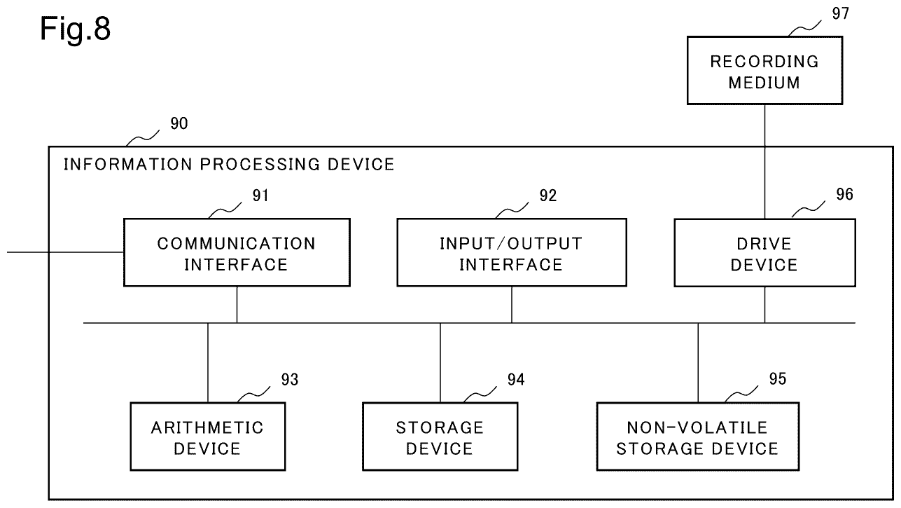

FIG. 8 is a diagram schematically illustrating a hardware configuration example of an information processing device capable of achieving the interference information output device according to each example embodiment of the present invention. An information processing device 90 includes a communication interface 91, an input/output interface 92, an arithmetic device 93, a storage device 94, a non-volatile storage device 95, and a drive device 96.

For example, the reception unit 11 and the output unit 14 in FIG. 1 can be achieved by the communication interface 91 and the arithmetic device, and the calculation unit 12 and the estimation unit 13 can be achieved by the arithmetic device 93.

The communication interface 91 is a communication means for the interference information output device according to each example embodiment to communicates with an external device in wired or/and wireless manner. When the interference information output device is achieved by using at least two information processing devices, the devices may be mutually communicably connected via the communication interface 91.

The input/output interface 92 is a keyboard being one example of an input device and a man-machine interface such as a display as an output device.

The arithmetic device 93 is achieved by an arithmetic processing device such as a general-purpose central processing unit (CPU) and a microprocessor or a plurality of electric circuits. The arithmetic device 93, for example, reads various types of programs stored in the non-volatile storage device 95 onto the storage device 94 and thereby, can execute processing in accordance with the read programs.

The storage device 94 is a memory device such as a Random Access Memory (RAM) referable to from the arithmetic device 93 and stores a program and various types of data. The storage device 94 may be a volatile memory device.

The non-volatile storage device 95 is a non-volatile storage device, for example, such as a Read Only Memory (ROM) and a flash memory and can store various types of programs, data, and the like.

The drive device 96 is, for example, a device for processing read and write of data for a recording medium 97 to be described later.

The recording medium 97 is any recording medium capable of recording data, for example, such as an optical disc, a magneto-optical disk, and a semiconductor flash memory.

Each example embodiment according to the present invention may be achieved by configuring an interference information output device by using, for example, the information processing device 90 illustrated in FIG. 8 and supplying, to the interference information output device, a program capable of achieving the function described according to each example embodiment described above.

In this case, the program supplied to the interference information output device is executed by the arithmetic device 93 and thereby, the example embodiment can be achieved. Not all function but a part of the function of the interference information output device can be configured by using the information processing device 90.

The program is recorded in the recording medium 97, and in a shipping stage or an operation stage of the interference information output device, the interference information output device may be configured in such a way that the program is appropriately stored in the non-volatile storage device 95. In this case, as a supply method for the program, a method of installation into the interference information output device using an appropriate tool in a production stage before shipment, an operation stage, or the like may be adopted. As a supply method for the program, a general procedure such as a download method from an outside via a communication line such as the Internet may be adopted.

The whole or part of the example embodiments disclosed above can be described as, but not limited to, the following supplementary notes.

### (Supplementary Note 1)

An interference information output device comprising:
a reception means for receiving, with respect to a plurality of wireless communication terminals, location information being information relating to presence locations of the wireless communication terminals;
a calculation means for calculating, based on the location information, a degree of congestion of the wireless communication terminals;
an estimation means for estimating, based on an estimation condition, occurrence of radio wave interference; and
an output means for outputting interference information being information relating to a result of the estimation, wherein
the estimation condition includes a condition relating to the degree of congestion.

### (Supplementary Note 2)

The interference information output device according to supplementary note 1, wherein
the degree of congestion is a number of the wireless communication terminals per unit volume or per unit area.

### (Supplementary Note 3)

The interference information output device according to supplementary note 1 or 2, wherein
the location information includes operation information of the wireless communication terminal, and
the operation information is information relating to an operation of the wireless communication terminal.

### (Supplementary Note 4)

The interference information output device according to supplementary note 3, wherein
the estimation means conducts, based on the operation information and the estimation condition, the estimation for a date and time in at least any one of a present, a future, or a past.

### (Supplementary Note 5)

The interference information output device according to supplementary note 4, wherein
the estimation means estimates, based on the estimation condition and the operation information of the specific wireless communication terminal, whether, in a location where the wireless communication terminal passes, radio wave interference occurs in a date and time in which the wireless communication terminal is scheduled to pass, and
the interference information includes, with respect to the wireless communication terminal, information of a date and time in which occurrence of radio wave interference is estimated.

### (Supplementary Note 6)

The interference information output device according to any one of supplementary notes 1 to 5, wherein
the output means outputs the interference information to a display means for displaying an image,
the interference information is image information for displaying the image in the display means, and
the image is an image in which a result of the estimation is displayed on a map.

### (Supplementary Note 7)

The interference information output device according to any one of supplementary notes 1 to 6, wherein
the estimation means calculates, based on the location information, a movement direction for avoiding an area in which occurrence of radio wave interference is estimated, with respect to the specific wireless communication terminal, and
the interference information includes information relating to the movement direction for the wireless communication terminal.

### (Supplementary Note 8)

The interference information output device according to supplementary note 7, wherein
the interference information includes control information for moving the wireless communication terminal in the movement direction.

### (Supplementary Note 9)

An interference information output method comprising:
receiving, with respect to a plurality of wireless communication terminals, location information being information relating to presence locations of the wireless communication terminals;
calculating, based on the location information, a degree of congestion of the wireless communication terminals;
estimating, based on an estimation condition, occurrence of radio wave interference; and
outputting interference information being information relating to a result of the estimation, wherein
the estimation condition includes a condition relating to the degree of congestion.

### (Supplementary Note 10)

The interference information output method according to supplementary note 9, wherein
the degree of congestion is a number of the wireless communication terminals per unit volume or per unit area.

### (Supplementary Note 11)

The interference information output method according to supplementary note 9 or 10, wherein
the location information includes operation information of the wireless communication terminal, and
the operation information is information relating to an operation of the wireless communication terminal.

### (Supplementary Note 12)

The interference information output method according to supplementary note 11, wherein,
based on the operation information and the estimation condition, the estimation is conducted for a date and time in at least any one of a present, a future, or a past.

### (Supplementary Note 13)

The interference information output method according to supplementary note 12, wherein
it is estimated that based on the estimation condition and the operation information of the specific wireless communication terminal, whether in a location where the wireless communication terminal passes, radio wave interference occurs in a date and time in which the wireless communication terminal is scheduled to pass, and
the interference information includes, with respect to the wireless communication terminal, information of a date and time in which occurrence of radio wave interference is estimated.

### (Supplementary Note 14)

The interference information output method according to any one of supplementary notes 9 to 13, wherein
the interference information is output to a display means for displaying an image,
the interference information is image information for displaying the image in the display means, and
the image is an image in which a result of the estimation is displayed on a map.

### (Supplementary Note 15)

The interference information output method according to any one of supplementary notes 9 to 14, wherein,
based on the location information, a movement direction for avoiding an area in which occurrence of radio wave interference is estimated is calculated with respect to the specific wireless communication terminal, and
the interference information includes information relating to the movement direction for the wireless communication terminal.

### (Supplementary Note 16)

The interference information output method according to supplementary note 15, wherein
the interference information includes control information for moving the wireless communication terminal in the movement direction.

### (Supplementary Note 17)

A computer-readable recording medium recording an interference information output program causing a computer to achieve:
a reception function of receiving, with respect to a plurality of wireless communication terminals, location information being information relating to presence locations of the wireless communication terminals:
a calculation function of calculating, based on the location information, a degree of congestion of the wireless communication terminals;
an estimation function of estimating, based on an estimation condition, occurrence of radio wave interference; and
an output function of outputting interference information being information relating to a result of the estimation, wherein
the estimation condition includes a condition relating to the degree of congestion.

### (Supplementary Note 18)

The computer-readable recording medium recording an interference information output program according to supplementary note 17, wherein
the degree of congestion is a number of the wireless communication terminals per unit volume or per unit area.

### (Supplementary Note 19)

The computer-readable recording medium recording an interference information output program according to supplementary note 17 or 18, wherein
the location information includes operation information of the wireless communication terminal, and
the operation information is information relating to an operation of the wireless communication terminal.

### (Supplementary Note 20)

The computer-readable recording medium recording an interference information output program according to supplementary note 19, wherein
the estimation function conducts, based on the operation information and the estimation condition, the estimation for a date and time in at least any one of a present, a future, or a past.

### (Supplementary Note 21)

The computer-readable recording medium recording an interference information output program according to supplementary note 20, wherein
the estimation function estimates, based on the estimation condition and the operation information of the specific wireless communication terminal, whether in a location where the wireless communication terminal passes, radio wave interference occurs in a date and time in which the wireless communication terminal is scheduled to pass, and
the interference information includes, with respect to the wireless communication terminal, information of a date and time in which occurrence of radio wave interference is estimated.

### (Supplementary Note 22)

The computer-readable recording medium recording an interference information output program according to any one of supplementary notes 17 to 21, wherein
the output function outputs the interference information to a display means for displaying an image,
the interference information is image information for displaying the image in the display means, and
the image is an image in which a result of the estimation is displayed on a map.

### (Supplementary Note 23)

The computer-readable recording medium recording an interference information output program according to any one of supplementary notes 17 to 22, wherein
the estimation function calculates, based on the location information, a movement direction for avoiding an area in which occurrence of radio wave interference is estimated, with respect to the specific wireless communication terminal, and
the interference information includes information relating to the movement direction for the wireless communication terminal.

### (Supplementary Note 24)

The computer-readable recording medium recording an interference information output program according to supplementary note 23, wherein
the interference information includes control information for moving the wireless communication terminal in the movement direction.

### (Supplementary Note 25)

An interference information output system comprising:
a reception means for receiving, with respect to a plurality of wireless communication terminals, location information being information relating to presence locations of the wireless communication terminals;
a calculation means for calculating, based on the location information, a degree of congestion of the wireless communication terminals;
an estimation means for estimating, based on an estimation condition, occurrence of radio wave interference; and
an output means for outputting interference information being information relating to a result of the estimation, wherein
the estimation condition includes a condition relating to the degree of congestion.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

10, 20, 30 Interference information output device
11, 21 Reception unit
12, 22 Calculation unit
13, 23 Estimation unit
14, 24 Output unit
35 Condition generation unit
60 Location information management device
70 Display means
90 Information processing device
91 Communication interface
92 Input/output interface
93 Arithmetic device
94 Storage device
95 Non-volatile storage device
96 Drive device
97 Recording medium

What is claimed is:

1. An interference information output device comprising one or more memories storing instructions and one or more processors configured to execute the instructions to:
receiving, receive, with respect to a plurality of wireless communication terminals, location information being information relating to presence locations of the wireless communication terminals;
calculate, based on the location information, a degree of congestion of the wireless communication terminals;
estimate, based on an estimation condition, occurrence of radio wave interference; and
output interference information being information relating to a result of the estimation, wherein
the estimation condition includes a condition relating to the degree of congestion.

2. The interference information output device according to claim 1, wherein
the degree of congestion is a number of the wireless communication terminals per unit volume or per unit area.

3. The interference information output device according to claim 1, wherein
the location information includes operation information of the wireless communication terminal, and
the operation information is information relating to an operation of the wireless communication terminal.

4. The interference information output device according to claim 3, wherein
based on the operation information and the estimation condition, the estimation is conducted for a date and time in at least any one of a present, a future, or a past.

5. The interference information output device according to claim 4, wherein
it is estimated that, based on the estimation condition and the operation information of the specific wireless communication terminal, whether, in a location where the wireless communication terminal passes, radio wave interference occurs in a date and time in which the wireless communication terminal is scheduled to pass, and
the interference information includes, with respect to the wireless communication terminal, information of a date and time in which occurrence of radio wave interference is estimated.

6. The interference information output device according to claim 1, wherein
the interference information is output to display means for displaying an image,
the interference information is image information for displaying the image in the display means, and
the image is an image in which a result of the estimation is displayed on a map.

7. The interference information output device according to claim 1, wherein
based on the location information and the estimation condition, a movement direction for avoiding an area in which occurrence of radio wave interference is estimated is calculated, with respect to the specific wireless communication terminal, and
the interference information includes information relating to the movement direction for the wireless communication terminal.

8. The interference information output device according to claim 7, wherein
the interference information includes control information for moving the wireless communication terminal in the movement direction.

9. An interference information output method comprising:
receiving, with respect to a plurality of wireless communication terminals, location information being information relating to presence locations of the wireless communication terminals;
calculating, based on the location information, a degree of congestion of the wireless communication terminals;
estimating, based on an estimation condition, occurrence of radio wave interference; and
outputting interference information being information relating to a result of the estimation, wherein
the estimation condition includes a condition relating to the degree of congestion.

10. The interference information output method according to claim 9, wherein
the degree of congestion is a number of the wireless communication terminals per unit volume or per unit area.

11. The interference information output method according to claim 9, wherein
the location information includes operation information of the wireless communication terminal, and
the operation information is information relating to an operation of the wireless communication terminal.

12. The interference information output method according to claim 11, wherein,
based on the operation information and the estimation condition, the estimation is conducted for a date and time in at least any one of a present, a future, or a past.

13. The interference information output method according to claim 12, wherein
it is estimated that, based on the estimation condition and the operation information of the specific wireless communication terminal, whether, in a location where the wireless communication terminal passes, radio wave interference occurs in a date and time in which the wireless communication terminal is scheduled to pass, and
the interference information includes, with respect to the wireless communication terminal, information of a date and time in which occurrence of radio wave interference is estimated.

14. The interference information output method according to claim 9, wherein
the interference information is output to display means for displaying an image,
the interference information is image information for displaying the image in the display means, and
the image is an image in which a result of the estimation is displayed on a map.

15. The interference information output method according to claim 9, wherein,
based on the location information, a movement direction for avoiding an area in which occurrence of radio wave interference is estimated is calculated with respect to the specific wireless communication terminal, and
the interference information includes information relating to the movement direction for the wireless communication terminal.

16. The interference information output method according to claim 15, wherein
the interference information includes control information for moving the wireless communication terminal in the movement direction.

17. A non-transitory computer-readable recording medium recording an interference information output program causing a computer to achieve:
a reception function of receiving, with respect to a plurality of wireless communication terminals, location information being information relating to presence locations of the wireless communication terminals;
a calculation function of calculating, based on the location information, a degree of congestion of the wireless communication terminals;
an estimation function of estimating, based on an estimation condition, occurrence of radio wave interference; and
an output function of outputting interference information being information relating to a result of the estimation, wherein
the estimation condition includes a condition relating to the degree of congestion.

18. The non-transitory computer-readable recording medium recording an interference information output program according to claim 17, wherein
the degree of congestion is a number of the wireless communication terminals per unit volume or per unit area.

19. The non-transitory computer-readable recording medium recording an interference information output program according to claim 17, wherein
the location information includes operation information of the wireless communication terminal, and
the operation information is information relating to an operation of the wireless communication terminal.

20. The non-transitory computer-readable recording medium recording an interference information output program according to claim 19, wherein
the estimation function conducts, based on the operation information and the estimation condition, the estimation for a date and time in at least any one of a present, a future, or a past.

21-25. (canceled)
